(19) United States
(12) Patent Application Publication
(10) Pub. No.: US 2002/0051330 A1
(43) Pub. Date: May 2, 2002

(54) High resistance CPP transducer in a read/write head

(75) Inventors: Petrus Antonius Van der Heijden, Cranberry Twp, PA (US); Robert E. Rottmayer, Pittsburgh, PA (US); Michael Allen Seigler, Pittsburgh, PA (US)

Correspondence Address: SCHWEGMAN, LUNDBERG, WOESSNER & KLUTH, P.A., P.O. BOX 2938, MINNEAPOLIS, MN, 55402, US

(73) Assignee: Seagate Technology LLC

(21) Appl. No.: 09/930,925

(22) Filed: Aug. 16, 2001

Related U.S. Application Data
(60) Provisional application No. 60/245,049, filed on Nov. 1, 2000.

(51) Int. Cl. G11B 5/39

(52) U.S. Cl. 360/324; 360/320

(57) ABSTRACT

According to one embodiment of the present invention, a read/write head for a disc drive includes an active stack between and in contact with a first shield and a second shield. The active stack includes a plurality of layers and a non-continuous insulating interlayer. According to another embodiment, a sense current is coupled through the active stack that has two larger dimensions and a smaller dimension. The sense current is coupled to flow in a direction that is approximately normal or perpendicular to a plane defined by the two larger dimensions. Changes in the sense current are detected to detect changes in flux fields caused by changes in magnetic flux regions in a magnetizable medium. According to another embodiment, the active stack is fabricated by fabricating the plurality of layers, and fabricating the non-continuous insulating interlayer in contact with one of the layers.

### RELATED APPLICATION

This application claims the benefit of U.S. Provisional Application Serial No. 60/245,049 filed on Nov. 1, 2000 under 35 USC 119(e).

### FIELD OF THE INVENTION

The present invention relates to the field of disc drive data storage devices. More particularly, this invention relates to a high resistance CPP transducer in a read/write head.

### BACKGROUND OF THE INVENTION

An important device in any computer system is a data storage device. A disc drive is a storage device having the capacity to store data and instructions. The disc drive has one or more discs, each with two surfaces on which data is stored. The surfaces are coated with ferromagnetic media having regions that are magnetized in alternate directions to store the data and instructions. The coated surfaces are computer-readable media holding computer-readable data and computer-readable and computer-executable instructions. The discs are mounted on a hub of a spindle motor for rotation at an approximately constant high speed during the operation of the disc drive. An actuator assembly in the disc drive moves magnetic transducers, also called read/write heads, to various locations relative to the discs while the discs are rotating, and electrical circuitry is used to write data to and read data from the media through the read/write heads. Data and instructions are stored in the media of one or both of the surfaces of each disc. The disc drive also includes circuitry for encoding data and instructions written to the media and for decoding data and instructions read from the media. A microprocessor controls most operations of the disc drive, such as transmitting information including instructions or data read from the media back to a requesting computer and receiving data or information from the requesting computer for writing to the media.

Information representative of data or instructions is stored in tracks in the media. A read/write head is positioned over a track to write information to or read information from the track. Each read/write head is typically located on a slider that is supported by the actuator assembly. The actuator assembly is controlled to position the read/write head over the media of one of the discs.

Conventional read/write heads include an inductive write element to write information to the media and a magnetoresistive (MR) element to read information from the media. Information is written inductively using a pair of magnetic write poles which form a magnetic path and define a transducing magnetically nonconductive gap in a pole tip region. The magnetically nonconductive gap is positioned to fly close to the media. An electrical coil is located between the poles to provide current representative of the information and to cause flux flow in the magnetic path of the poles.

The MR element includes a stack of layers of magnetically conductive and nonconductive materials such as cobalt and copper. Each layer of the MR element has a thickness and an approximately rectangular area defined by a track width of each track in the media and a stripe height. The MR element is spaced from a set of magnetic shields that shield the MR element from magnetic fields other than those in the media. The MR element is positioned to fly close to the media to read information from the media. A sense current is passed through the MR element to sense an electrical resistance of the MR element, which changes in response to changes in an amount and direction of magnetic flux in and near the media.

MR elements may be operated in a current perpendicular-to-the-plane (CPP) mode in which the sense current flows through the stack in a direction approximately normal or perpendicular to a plane defined by the two largest dimensions of each layer in the stack, the track width and the stripe height. Such MR elements may be called CPP transducers. MR elements are being used to read information from high density disc drives which store information in ferromagnetic media at a very high density. Conventional CPP transducers are not sensitive enough to accurately read information that is stored in a highly dense fashion.

There is a need for a CPP transducer with an improved sensitivity that is capable of accurately reading information stored in a high density fashion in ferromagnetic media.

### SUMMARY OF THE INVENTION

According to one embodiment of the present invention, a read/write head for a disc drive includes an active stack between and in contact with a first shield and a second shield. The active stack includes a plurality of layers and a non-continuous insulating interlayer. According to another embodiment of the present invention, a sense current is coupled through the active stack that has two larger dimensions and a smaller dimension. The sense current is coupled to flow in a direction that is approximately normal or perpendicular to a plane defined by the two larger dimensions of the active stack. A detection of changes in the sense current is used to determine changes in flux fields caused by changes in magnetic flux regions in a magnetizable medium. According to another embodiment of the present invention, fabricating the active stack includes fabricating the plurality of layers, and fabricating the non-continuous insulating interlayer in contact with one of the layers. The active stack may be used with equal success in longitudinal and perpendicular read/write heads according to embodiments of the present invention.

Advantageously, the embodiments of the present invention provide for an accurate reading of information that is stored in a high density fashion in ferromagnetic media. CPP transducers described herein according to embodiments of the present invention include a non-continuous insulating interlayer that increases the resistance of an active stack in the CPP transducer. The increased resistance results in greater fluctuations in a sense current in the active stack when the active stack is exposed to a time-varying magnetic flux in the ferromagnetic media. The increased fluctuations in the sense current are easier to detect, and improve the accuracy of reading information that is stored in a high density fashion in ferromagnetic media.

### BRIEF DESCRIPTION OF THE DRAWINGS

FIG. 1 is an exploded view of a disc drive according to an embodiment of the present invention.

FIG. 2 is a cross-sectional view of a read/write head according to an embodiment of the present invention.

FIG. 3 is a cross-sectional view of a read/write head according to an embodiment of the present invention.

FIG. 4 is a cross-sectional view of a CPP transducer according to the prior art.

FIG. 5 is a cross-sectional view of a CPP transducer according to an embodiment of the present invention.

FIG. 6 is an oblique view of a CPP transducer according to an embodiment of the present invention.

FIG. 7 is an oblique view of a partially oxidized layer according to an embodiment of the present invention.

FIGS. 8-1, 8-2, and 8-3 show the fabrication of a partially oxidized layer according to an embodiment of the present invention.

FIG. 9 is a cross-sectional view of a CPP transducer according to an embodiment of the present invention.

FIG. 10 is a cross-sectional view of a CPP transducer according to an embodiment of the present invention.

FIG. 11 is a cross-sectional view of a CPP transducer according to an embodiment of the present invention.

FIG. 12 is a cross-sectional view of a CPP transducer according to an embodiment of the present invention.

FIG. 13 is a side view of a read/write head according to an embodiment of the present invention.

FIG. 14 is a cross-sectional view of a main magnetic pole of a perpendicular read/write head according to an embodiment of the present invention.

FIG. 15 is a cross-sectional view of a main magnetic pole of a perpendicular read/write head according to an embodiment of the present invention.

FIG. 16 is a block diagram of a disc drive according to an embodiment of the present invention.

FIG. 17 is a block diagram of an information handling system according to an embodiment of the present invention.

### DESCRIPTION OF THE EMBODIMENTS

In the following detailed description of exemplary embodiments of the present invention, reference is made to the accompanying drawings which form a part hereof, and in which are shown by way of illustration specific exemplary embodiments in which the present invention may be practiced. These embodiments are described in sufficient detail to enable those skilled in the art to practice the present invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the claims. In the following description, similar elements retain the same reference numerals for purposes of clarity.

In the following description, the abbreviation form Ex/Mx will be used to describe electrical and magnetic conductivity properties of various materials, with x=C meaning the material is conductive, x=N meaning the material is nonconductive, and x=X meaning the material can be either. For example, EN/MC means the material is electrically nonconductive and magnetically conductive. EX/MN means the material is either electrically conductive or nonconductive, but it is magnetically nonconductive. Several read/write heads will be described herein, each having one or more shields comprising an EC/MC material. Such shields may also be referred to as pole/shield layers.

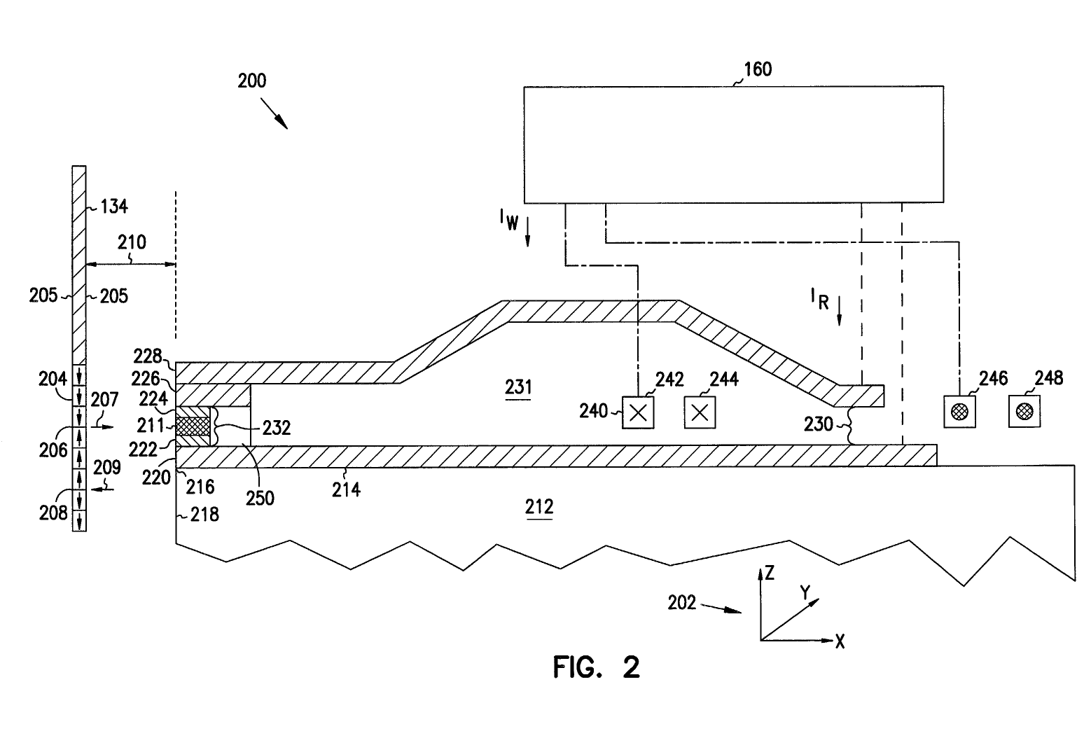

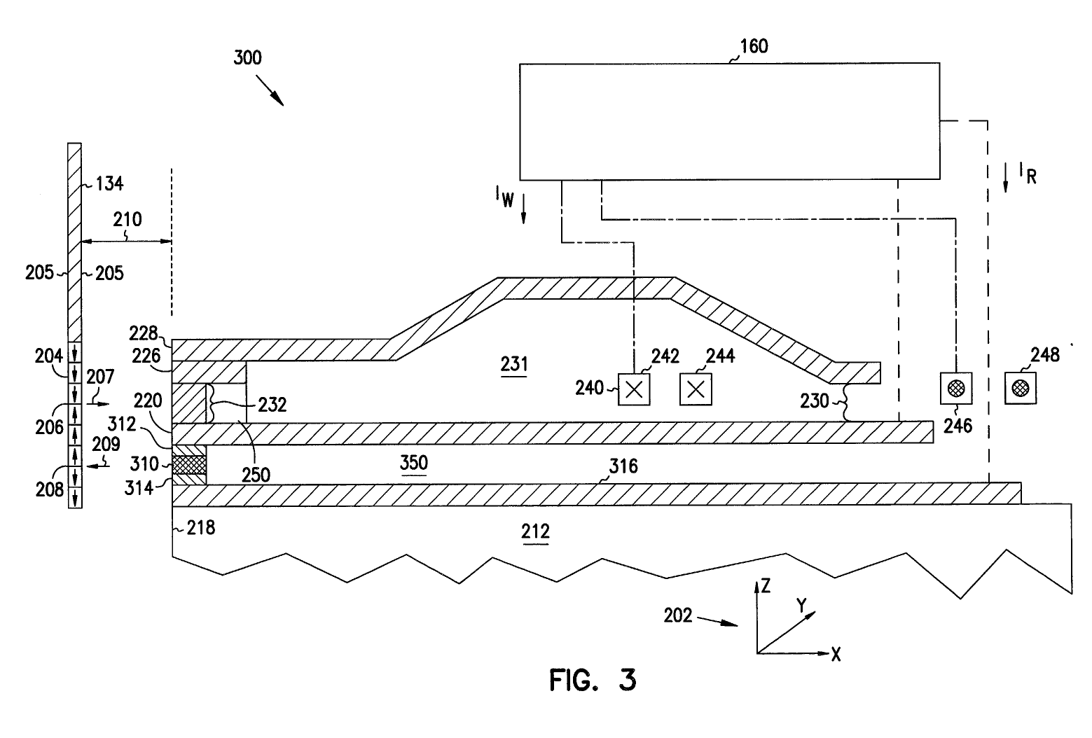

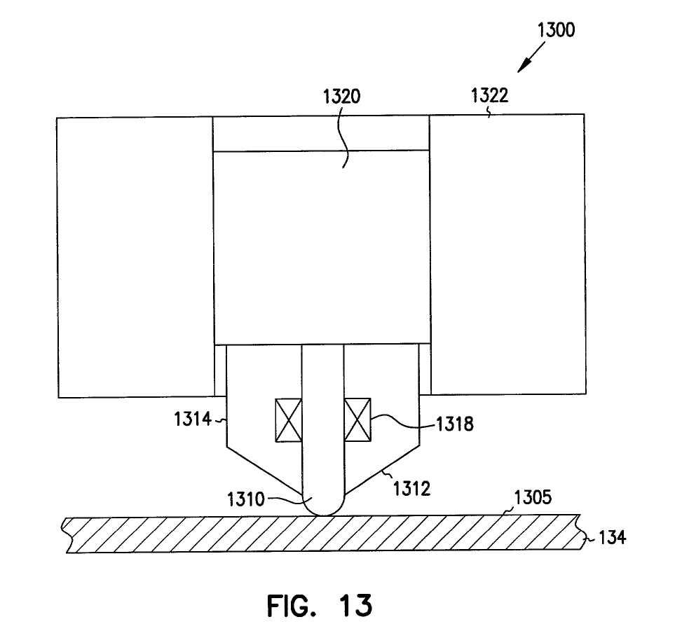

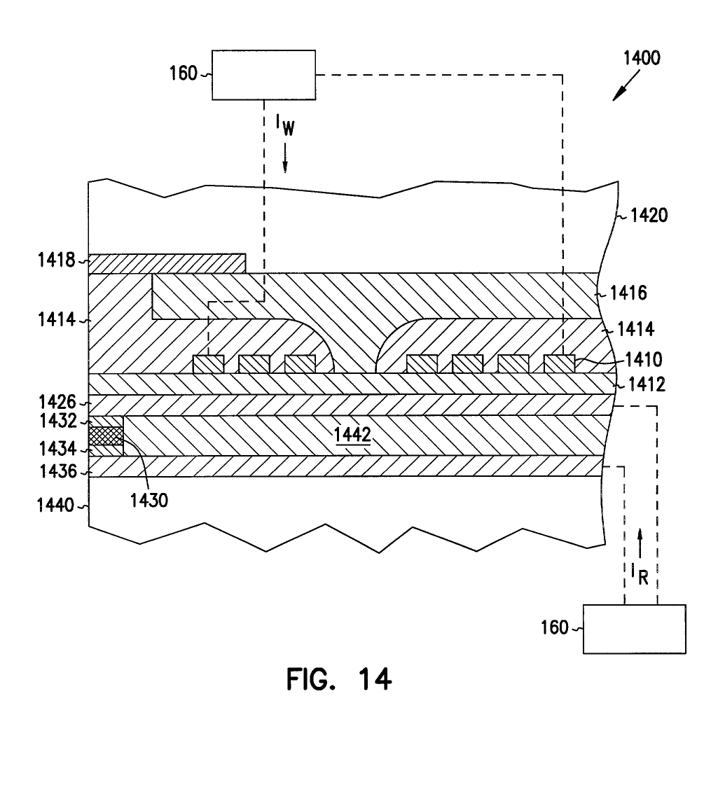

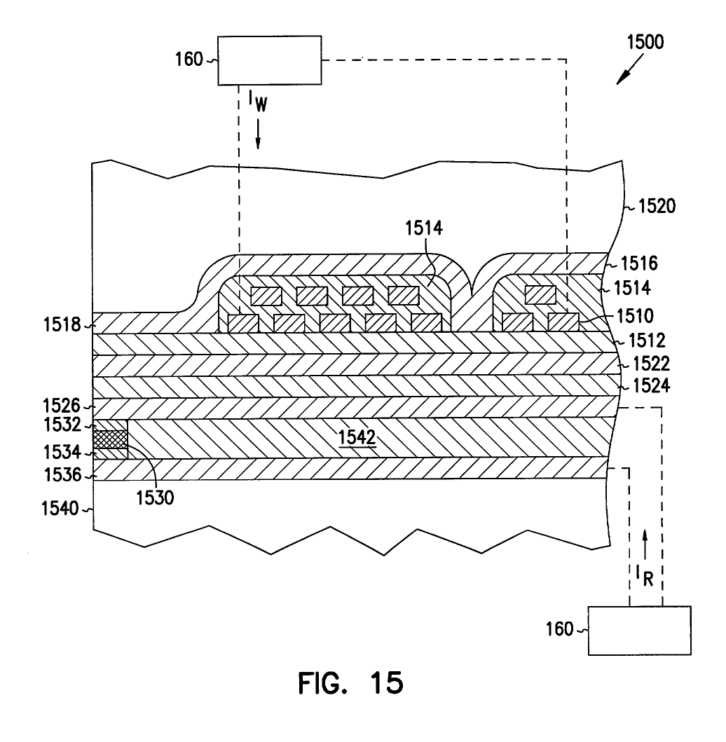

In the following description, several active stacks will be described according to embodiments of the present invention. The term active stack refers to a structure that undergoes changes in its electrical resistance as it passes a flux field. Each active stack includes layers that are active in a magnetic structure of a read/write head according to embodiments of the present invention. Each active stack may have other characteristics as well. The active stacks described herein and their equivalents may be used with equal success in longitudinal read/write heads such as those shown in FIG. 2 and FIG. 3, and in perpendicular read/write heads such as those shown in FIG. 13, FIG. 14, and FIG. 15 according to embodiments of the present invention.

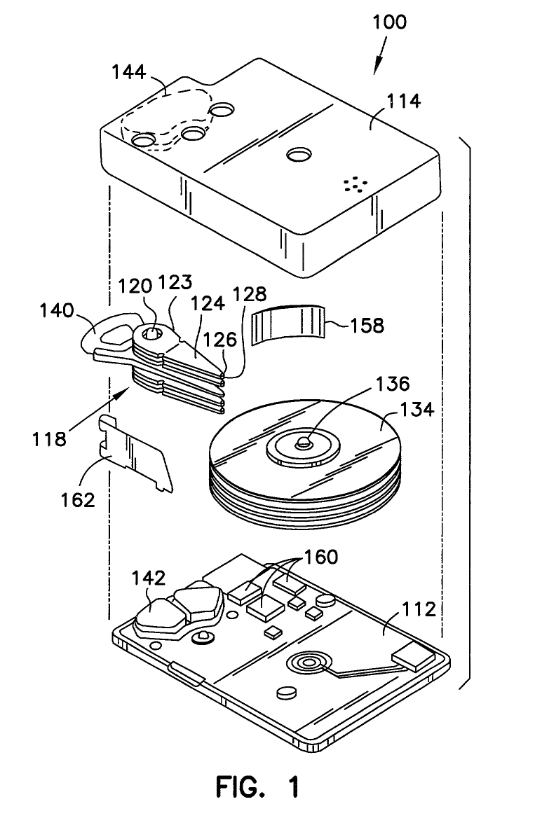

The embodiments of the present invention described in this application are useful with all types of disc drives, including hard disc drives, zip drives, media storage drives, tape drives, and floppy disc drives. An exploded view of a disc drive 100 is shown in FIG. 1 according to an embodiment of the present invention. The disc drive 100 includes a housing or base 112 and a cover 114. The base 112 and cover 114 form a disc enclosure. An actuator assembly 118 is rotatably mounted to an actuator shaft 120, and the actuator shaft 120 is mounted to the base 112. The actuator assembly 118 includes a comb-like structure of a plurality of arms 123. A load spring 124 extends from and is attached to each arm 123. The load springs 124 are also referred to as suspensions, flexures, or load beams. A slider 126 is attached to an end of each load spring 124, and each slider 126 carries a read/write head 128. Each slider 126 is a small ceramic block which is passed over one of several discs 134.

The discs 134 each have two surfaces, and information is stored on one or both of the surfaces. The surfaces are coated with a magnetizable medium such as a ferromagnetic media that is magnetized in alternate directions to store the information. The surfaces are computer-readable media holding the information including computer-readable data and computer-readable and computer-executable instructions. The information is arranged in tracks in the media of the discs 134. The discs 134 are mounted on a hub 136 of a spindle motor (not shown) for rotation at an approximately constant high speed. Each slider 126 is moved over the media of one of the discs 134 by the actuator assembly 118 as the discs 134 rotate so that the read/write head 128 may read information from or write information to the surface of the disc 134. The embodiments of the present invention described herein are equally applicable to disc drives which have a plurality of discs or a single disc attached to a spindle motor, and to disc drives with spindle motors which are either under a hub or within the hub. The embodiments of the present invention are equally applicable to disc drives in which information is stored in a multiplicity of concentric circular tracks in the media of each disc, or in disc drives in which information is stored in a single track arranged as a continuous spiral in the media of each disc. Each slider 126 is held over the media of one of the discs 134 by opposing forces from the load spring 124 forcing the slider 126 toward the media and air pressure on an air bearing surface of the slider 126 caused by the rotation of the discs 134 lifting the slider 126 away from the media. The embodiments of the present invention described herein are equally applicable to sliders 126 having more than one read/write head 128.

A voice coil 140 is mounted to the actuator assembly 118 opposite the load springs 124 and the sliders 126. The voice coil 140 is immersed in a magnetic field of a first permanent magnet 142 attached to the base 112, and a second permanent magnet 144 attached to the cover 114. The permanent magnets 142, 144, and the voice coil 140 are components of a voice coil motor which is controlled to apply a torque to the actuator assembly 118 to rotate it about the actuator shaft 120. Current is applied to the voice coil 140 in a first direction to generate an electromagnetic field that interacts with the magnetic field of the permanent magnets 142, 144. The interaction of the magnetic fields applies a torque to the voice coil 140 to rotate the actuator assembly 118 about the actuator shaft 120, and the actuator assembly 118 is accelerated to move the read/write head 128 to a new position. The disc drive 100 includes an internal filter 158.

The disc drive 100 includes one or more integrated circuits 160 coupled to the actuator assembly 118 through a flexible cable 162. The integrated circuits 160 may be coupled to control current in the voice coil 140 and resulting movements of the actuator assembly 118. The integrated circuits 160 may also be coupled to the read/write head 128 in the slider 126 for providing a signal to the read/write head 128 when information is being written to the media on the discs 134 and for receiving and processing a read/write signal generated by the read/write head 128 when information is being read from the media on the discs 134. A feedback control system in the integrated circuits 160 may receive servo information read from the media through the read/write heads 128. The feedback control system determines a position error signal from the servo information. If the read/write heads 128 are not in a correct position, they are moved to a desired position over a target track in response to the position error signal. The circuits 160 may include a microprocessor, a digital signal processor, one or more solid state machines, or hardwired circuits to control operations of the disc drive 100. The integrated circuits 160 may also include memory devices such as EEPROM and DRAM devices and modulation and amplification circuits.

A cross-sectional view of a longitudinal read/write head 200 is shown in FIG. 2 according to an embodiment of the present invention. The read/write head 200 is one example of the read/write head 128 shown in FIG. 1, and is shown positioned near a cross-sectional view of one of the discs 134 shown in FIG. 1. For purposes of reference, a Cartesian coordinate grid is shown at 202 having an upwardly extending Z axis and an X axis extending to the right. A Y axis extends orthogonally relative to the Z and X axes, inwardly into the plane of FIG. 2. The disc 134 has a plurality of pre-oriented magnetic flux regions 204 defined in a magnetizable medium 205 on its surface, each directed either in the +Z direction or the −Z direction. As an example, a first transition 206 is defined by opposite flux regions 204 to produce a first flux field 207 extending in the +X direction from the disc 134. A second transition 208 is defined by opposite flux regions 204 is shown producing a second flux field 209 extending in the −X direction. The surface of the disc 134 moves relative to the read/write head 200 in the Z direction (+Z or −Z). The read/write head 200 is spaced from the disc 134 in the X direction by an aerodynamically-defined flying height 210. An active stack 211 of a CPP transducer according to an embodiment of the present invention is located in the read/write head 200 and undergoes changes in its electrical resistance as it passes the flux fields 207 and 209. A ceramic slider 212 supports the read/write head 200. The slider 212 is shown in a cut-away view for purposes of brevity. The slider 212 has a top surface 214 extending in the X direction and a sidewall 218 extending in the Z direction. An edge where the top surface 214 meets the sidewall 218 is a forward edge 216. A first shield 220 comprises a material that is both magnetically and electrically conductive (an EC/MC material), is fabricated on the top surface 214 extending to the forward edge 216. The first shield 220 may comprise a nickel-iron composition, for example an alloy of 80% nickel (Ni) and 20% iron (Fe), or a ferromagnetic material with high permeability. A seed layer 222 is fabricated over a forward portion of the first shield 220, near the forward edge 216. The active stack 211 is fabricated over the seed layer 222, and a cap layer 224 is fabricated over the active stack 211.

A second shield 226 is made of an EC/MC material that is the same or equivalent to that of the first shield 220, and is fabricated over the cap layer 224. The second shield 226 has a thickness in the Z direction that is substantially the same as or less than that of the first shield 220.

A third shield 228, made of an EC/MC material that is the same or equivalent to that of the first and second shields 220 and 226, is fabricated over the second shield 226 and extended in the X direction to define a back gap 230 with the first shield 220. The first and third shields, 220 and 228, extend beyond the elements 222, 211, 224, and 226 in the X direction. The third shield 228 has a thickness in the Z direction that is substantially the same as or greater than that of the first shield 220. The back gap 230 and an empty volume 231 between the third shield 228 and the first shield 220 is filled with a material that is at least electrically nonconductive (an EN/MX material) and that may be both magnetically and electrically nonconductive (EN/MN) such as Al₂O₃, hard-baked photoresist, or benzocyclobutene (BCB).

A space at the forward edge 216, between the first shield 220 and the second shield 226, defines a forward gap 232. The forward gap 232 has a dimension defined by the combined Z direction thicknesses of the seed layer 222, the active stack 211, and the cap layer 224.

A planar coil 240 has electrically conductive winding members such as indicated at 242, 244, 246, and 248. The planar coil 240 is fabricated about the back gap 230 and electrically insulated from the first and third shields, 220 and 228, by an appropriate EN/MN support structure (not shown). An electrically nonconductive (EN) magnetic biasing element 250 is positioned behind the seed layer 222, the active stack 211, and the cap layer 224. The biasing element 250 is also located between the first and second shields, 220 and 226.

The circuits 160, also shown in FIG. 1, are connected to opposed ends of the coil 240, such as 242 and 246, and during a write mode the circuits 160 send electrical current Iw passing in the +Y direction through the winding members 242 and 244 positioned on a forward side of the back gap 230, and sends electrical current passing in the −Y direction through the winding members 246 and 248 positioned on a rear side of the back gap 230 to induce flux flow through the forward gap 232 and the back gap 230. Changes in flux flow across the forward gap 232 produce the different magnetic orientations of the flux regions 204 in the disc 134 during a write operation.

The circuits 160 are also connected to opposed back ends of the first and third shields, 220 and 228. During a read mode, the circuits 160 send an electrical sense current I_{R} in the Z direction through the elements 222, 211, 224, and 226. The sense current I_{R} flows approximately normal or perpendicular to a plane defined by the two largest dimensions of the active stack 211. The active stack 211 undergoes changes in its electrical resistance as it passes the flux fields 207 and 209, and the changes in the resistance of the active stack 211 are sensed by the circuits 160 by sensing changes in the sense current I_{R}, or by sensing changes in a voltage drop across the active stack 211 when the sense current I_{R} remains approximately constant.

A cross-sectional view of a longitudinal read/write head 300 is shown in FIG. 3 according to an embodiment of the present invention. The read/write head 300 is one example of the read/write head 128 shown in FIG. 1, and is shown positioned near a cross-sectional view of one of the discs 134 shown in FIG. 1. The read/write head 300 has many elements similar to elements in the read/write head 200 shown in FIG. 2, and similar elements have been given the same reference numerals and will not be described hereinbelow for purposes of brevity.

The read/write head 300 has an active stack 310 of a CPP transducer that is located below the first shield 220, and outside the forward gap 232. The active stack 310 is separated from the first shield 220 by a cap layer 312. A seed layer 314 separates the active stack 310 from a soft magnetic layer 316 that comprises a material that is both magnetically and electrically conductive (an EC/MC material) such as a nickel-iron composition, such as an alloy of 80% nickel (Ni) and 20% iron (Fe), or a ferromagnetic material with high permeability. The soft magnetic layer 316 extends in the X direction to be connected to the circuits 160 to receive the sense current I_{R}. The sense current I_{R} flows through the soft magnetic layer 316, the seed layer 3 14, the active stack 3 10 in a direction approximately normal or perpendicular to a plane defined by the two largest dimensions of the active stack 310, the cap layer 312, the first shield 220, and back to the circuits 160. The active stack 310 undergoes changes in its electrical resistance as it passes the flux fields 207 and 209, and the changes in the resistance of the active stack 310 are sensed by the circuits 160 by sensing changes in the sense current I_{R}, or by sensing changes in a voltage drop across the active stack 310 when the sense current I_{R} remains approximately constant. A volume 350 between the soft magnetic layer 316 and the first shield 220 is filled with an EN/MX material such as A1₂O₃, hard-baked photoresist, or benzocyclobutene (BCB).

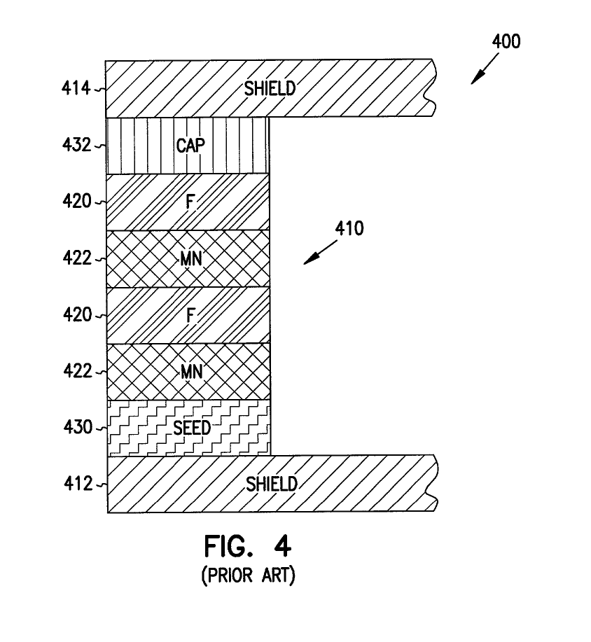

A cross-sectional view of a typical CPP transducer 400 is shown in FIG. 4 according to the prior art. The cross-sectional view of the CPP transducer 400 in FIG. 4 is not drawn to scale, and proportions of each element may be different in a fabricated CPP transducer 400. The CPP transducer 400 is a giant magnetoresistance (GMR) multilayer transducer, and is fabricated between a first shield 412 and a second shield 414. The CPP transducer 400 is fabricated by depositing an active stack 410 of two or more of a repeating pattern of a ferromagnetic layer (F) 420 and a magnetically nonconductive (MN) layer 422. The F and MN layers 420, 422 are deposited on a seed layer 430, and a cap layer 432 is deposited on the F and MN layers 420, 422 inside the second shield 414. The F and MN layers 420, 422 are deposited one after the other, and two or more depositions of each of the F and MN layers 420, 422 may comprise the active stack 410. The F and MN layers 420, 422 are electrically coupled to the first shield 412 and the second shield 414 such that a sense current may pass between the first shield, 412, the seed layer 430, the F and MN layers 420, 422, the cap layer 432, and the second shield 414.

Conventional CPP transducers such as the CPP transducer 400 shown in FIG. 4 present a low resistance to electrical current in the active stack 410. The low resistance of the active stack 410 results in small changes in a sense current passing through the active stack 410 as it is exposed to a time-varying magnetic flux, or in small changes in a voltage drop across the active stack 410 when the sense current remains approximately constant. These small changes in the sense current are not great enough to be sensed accurately to achieve an accurate reading of information that is stored in a high density fashion in ferromagnetic media.

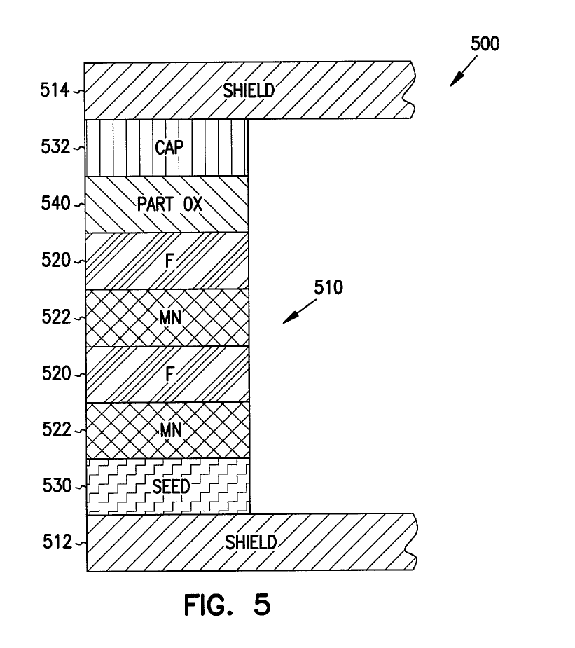

A cross-sectional view of a CPP transducer 500 is shown in FIG. 5 according to an embodiment of the present invention. The cross-sectional view of the CPP transducer 500 in FIG. 5 is not drawn to scale, and proportions of each element may be different in a fabricated CPP transducer 500. The CPP transducer 500 is a GMR multilayer transducer that has a high resistance, and comprises an active stack 510 between a first shield 512 and a second shield 514. The first shield 512 and the second shield 514 each comprise an electrically conductive and magnetically conductive (EC/MC) material such as a nickel-iron composition, for example an alloy of 80% nickel (Ni) and 20% iron (Fe), or a ferromagnetic material with high permeability.

The active stack 510 comprises two or more sets of a repeating pattern of a ferromagnetic layer (F) 520 and a magnetically nonconductive (MN) layer 522. The F and MN layers 520, 522 are deposited on a seed layer 530 located on the first shield 512, and a cap layer 532 is deposited between the F and MN layers 520, 522 and the second shield 514. The F and MN layers 520, 522 are deposited one after the other, and two or more depositions of each of the F and MN layers 520, 522 may be in the active stack 510. Each F layer 520 may comprise nickel (Ni), cobalt (Co), or iron (Fe), or their binary or tertiary alloy compositions. Each MN layer 522 may comprise silver (Ag), gold (Au), or copper (Cu).

In addition, the active stack 510 includes a non-continuous insulating interlayer 540. The non-continuous insulating interlayer 540 has portions that are electrically insulating that have a high resistance and portions that are not electrically insulating that provide a low resistance or an ohmic path for an electrical sense current I_{R}. The non-continuous insulating interlayer 540 effectively reduces the electrical cross-sectional area of the active stack 510 by blocking the sense current I_{R} with the electrically insulating portions and forcing the sense current I_{R} through the ohmic portions. The non-continuous insulating interlayer 540 increases the electrical resistance of the active stack 510 but does not change its magnetic cross-sectional area.

The non-continuous insulating interlayer 540 comprises a partially oxidized (PART OX) layer 540 of aluminum (Al) according to the embodiment of the present invention shown in FIG. 5, although other non-continuous insulating materials may be used. The PART OX layer 540 comprises portions of aluminum that are oxidized, also called aluminum oxide (AlOₓ), that have a high electrical resistance, and areas of aluminum (Al) that are not oxidized that provide an ohmic contact through the PART OX layer 540. The area of ohmic contact in the PART OX layer 540 is determined by the degree of oxidation of the aluminum (Al). The PART OX layer 540 is used because it is capable of substantially increasing the electrical resistance of the active stack 510 and does not require a substantial number of extra steps to fabricate. The PART OX layer 540 is located between the F and MN layers 520, 522 and the cap layer 532. The F and MN layers 520, 522, the PART OX layer 540, the seed layer 530, and the cap layer 532 are electrically coupled together to the first shield 512 and the second shield 514 such that an electrical sense current I_{R} may pass between the first shield 512, the seed layer 530, the F and MN layers 520, 522, the PART OX layer 540, the cap layer 532, and the second shield 514.

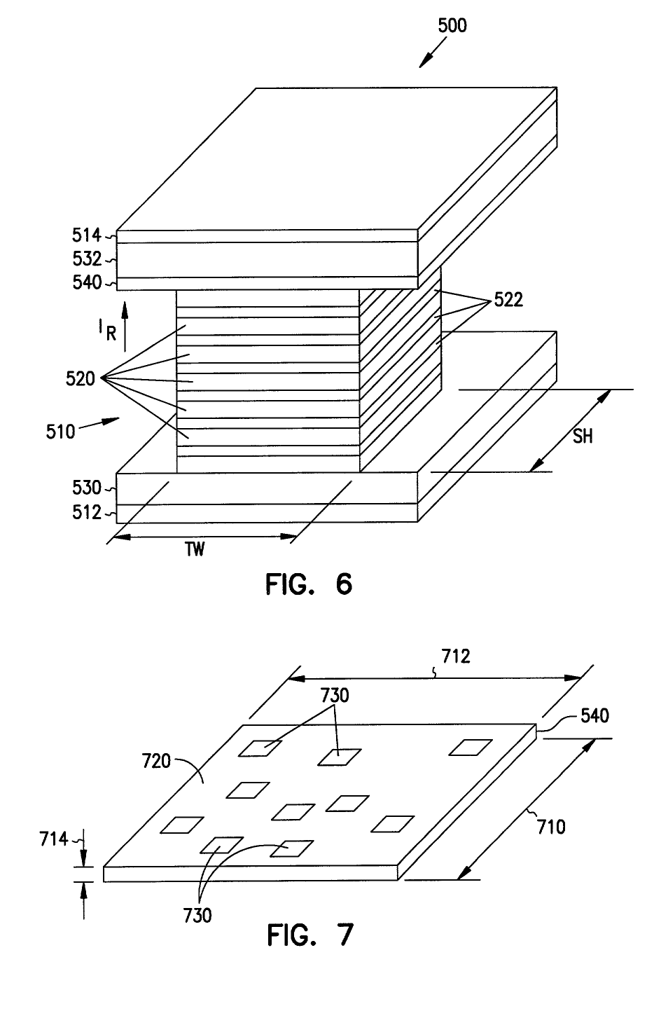

An oblique view of the CPP transducer 500 is shown in FIG. 6 according to an embodiment of the present invention. Each layer 520, 522 has two larger dimensions, a track width (TW) and a stripe height (SH). The smallest dimension of each layer 520, 522 is its thickness, which is approximately 20 angstroms. The electrical sense current I_{R} flows through the active stack 510 in a direction approximately normal or perpendicular to a plane defined by the two largest dimensions, TW and SH, of each layer 520 and 522. The electric resistance of a GMR element such as the CPP transducer 500 fluctuates when exposed to a time-varying magnetic flux, and this change in resistance can be sensed by sensing changes in the sense current I_{R}, or by sensing changes in a voltage drop across the active stack 510 when the sense current I_{R} remains approximately constant.

An oblique view of the PART OX layer 540 is shown in FIG. 7 according to an embodiment of the present invention. The PART OX layer 540 has two larger dimensions, a length 710 and a width 712. The smallest dimension of the PART OX layer 540 is its thickness 714. The PART OX layer 540 is a non-continuous insulating interlayer, and comprises high resistance aluminum oxide (AlOₓ) 720, surrounding pockets of lower resistance aluminum (Al) 730 which is not oxidized, and which provides an ohmic contact for the sense current I_{R}. The sense current I_{R} flows in a direction approximately normal or perpendicular to a plane defined by the length 710 and the width 712 of the PART OX layer 540. The PART OX layer 540 has an area defined by the length 710 and the width 712 that is as large as, or larger, than an area of the active stack 510 defined by the two larger dimensions TW and SH.

With reference to FIG. 5, during a read operation the electrical sense current I_{R} flows through the active stack 510 in a direction approximately normal or perpendicular to a plane defined by the two largest dimensions, TW and SH, of each layer 520 and 522 and a plane defined by the length 710 and the width 712 of the PART OX layer 540. The sense current I_{R} is forced around the aluminum oxide (AlOₓ) 720 and through the small ohmic portions of non-oxidized aluminum (Al) 730 in the PART OX layer 540. The PART OX layer 540 increases the resistance of the active stack 510 and results in greater fluctuations in the sense current I_{R} when the active stack 510 is exposed to a time-varying magnetic flux. The PART OX layer 540 also results in greater fluctuations in a voltage drop across the active stack 510 in a time-varying magnetic flux when the sense current I_{R} remains approximately constant. The active stack 510 with the PART OX layer 540 is capable of supporting an accurate reading of information that is stored in a high density fashion in ferromagnetic media.

The PART OX layer 540 can be located anywhere between the first shield 512 and the second shield 514. For example, the PART OX layer 540 can be in contact with the cap layer 532, as shown in FIG. 5. The PART OX layer 540 can also be in contact with the seed layer 530, or it may be located between any of the adjacent layers 520 and 522 in the active stack 510. The PART OX layer 540 can also be between the cap layer 532 and the second shield 514, or between the seed layer 530 and the first shield 512. There may also be multiple PART OX layers 540 distributed between the first shield 512 and the second shield 514 to increase the resistance of the active stack 510.

The seed layer 530 and the cap layer 532 may comprise tantalum (Ta), an alloy of nickel and iron (NiFe), an alloy of nickel, iron, and chromium (NiFeCr), copper (Cu), or other alloys containing chromium (Cr), iron (Fe), cobalt (Co), nickel (Ni) and/or copper (Cu). The seed layer 530 and the cap layer 532 may comprise different materials.

The layers in the CPP transducer 500 between the first shield 512 and the second shield 514, including the seed layer 530, the F and MN layers 520, 522, the PART OX layer 540, and the cap layer 532, are deposited, one at a time, by DC magnetron sputtering in the order shown in FIG. 5 and described above.

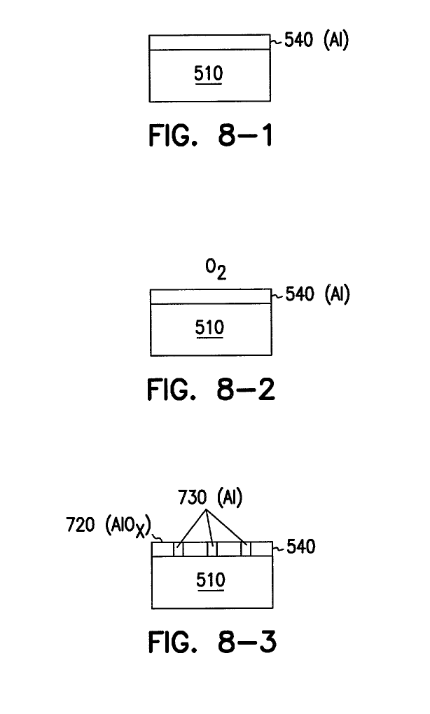

A fabrication of the PART OX layer 540 is shown in FIGS. 8-1, 8-2, and 8-3 according to an embodiment of the present invention. An aluminum (Al) layer 540 is deposited at a selected location in the active stack 510 by DC magnetron sputtering as shown in FIG. 8-1, and is fully ohmic. The aluminum (Al) layer 540 is then exposed to oxygen (0₂) in FIG. 8-2 and oxidation takes place. The oxidation transforms the aluminum (Al) layer 540 into the PART OX layer 540 when a selected percentage of the original aluminum (Al) is oxidized into the aluminum oxide (AlOₓ) 720, leaving a remaining portion of the original aluminum (Al) 730 that is ohmic as shown in FIG. 8-3. The exposure of the aluminum (Al) layer 540 to oxygen (0₂) is stopped, or the oxygen (0₂) is removed from contact with the aluminum (Al) layer 540, when the selected percentage of the original aluminum (Al) has been oxidized. The rate at which the original aluminum (Al) is oxidized is determined in part by the pressure of the oxygen (0₂). The time period of exposure and the pressure of the oxygen (0₂) are the primary parameters that determine the amount of oxidation of the aluminum (Al) layer 540. The percentage of aluminum (Al) that is oxidized is selected according to the desired increase in the resistance of the active stack 510, and may also be determined by the size of the active stack 510.

The ratio of the increase in the resistance of the active stack 510 is approximately equal to the reciprocal of the percentage of aluminum (Al) that is not oxidized. For example, if 90% of the PART OX layer 540 is aluminum oxide (AlOₓ), then the resistance of the active stack 510 will be increased by a factor of 10. If 95% of the PART OX layer 540 is aluminum oxide (AlOₓ), then the resistance of the active stack 510 will be increased by a factor of 20. The PART OX layer 540 does not require an extra photolithography step, and therefore is easy to fabricate.

The PART OX layer 540 may be fabricated in one of many ways according to embodiments of the present invention. For example, an aluminum (Al) layer may be deposited and oxidized by natural oxidation in pure oxygen or in the atmosphere, by UV assisted natural oxidation, by plasma oxidation (AC or DC), by oxidation employing alternative gases such as ozone, by NOₓ reactive deposition such as sputtering aluminum (Al) in an oxygen atmosphere, by deposition using a target with a desired oxide such as aluminum oxide (AlOₓ), or by electro-chemical oxidation of aluminum (Al). Each of the foregoing methods of fabrication has its own set of parameters that determine the amount of oxidation of the aluminum (Al) layer.

Also, the PART OX layer 540 may be an oxide of a material other than aluminum (Al). For example, the PART OX layer 540 may comprise an oxide of nickel (Ni), cobalt (Co), or iron (Fe), or their binary or tertiary alloys. The PART OX layer 540 may also comprise an oxide of copper (Cu) or tantalum (Ta).

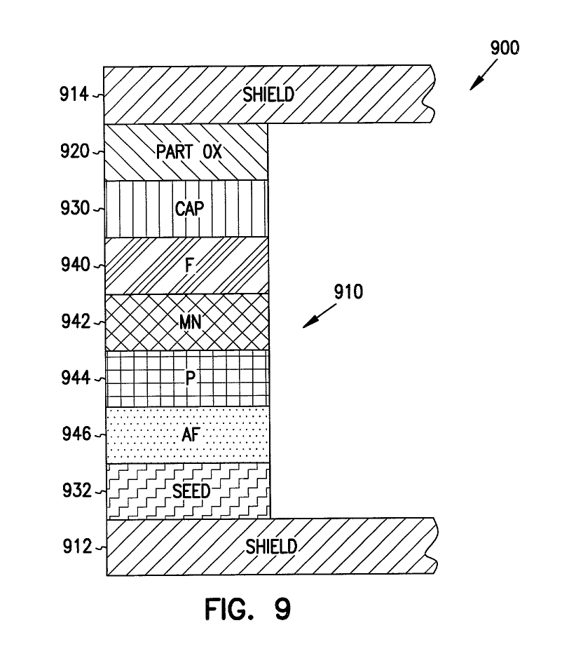

The non-continuous insulating interlayer such as the PART OX layer 540 shown in FIGS. 5, 6, and 7 may be used in other types of CPP transducers, other than the GMR multilayer transducer shown in FIG. 5. Alternative CPP transducers are shown in FIGS. 9, 10, 11, and 12 according to embodiments of the present invention, each with one or more non-continuous insulating interlayers. Layers that are identified as being similar to an individual layer in the CPP transducer 500 shown in FIG. 5 comprise the same material, and are fabricated in the same manner, as the corresponding layer in the CPP transducer 500 shown in FIG. 5. For example, F layers in any one of the CPP transducers comprise the same material that is deposited in the same way. These layers will not be further described for purposes of brevity.

A cross-sectional view of a CPP transducer 900 is shown in FIG. 9 according to an embodiment of the present invention. The cross-sectional view of the CPP transducer 900 in FIG. 9 is not drawn to scale, and proportions of each element may be different in a fabricated CPP transducer 900. The CPP transducer 900 is a bottom spin valve transducer that has a high resistance, and comprises an active stack 910 between a first shield 912 and a second shield 914. The active stack 910 includes a PART OX layer 920 between the second shield 914 and a cap layer 930 to increase the resistance of the active stack 910. Between the cap layer 930 and a seed layer 932, the active stack 910 includes an F layer 940, a MN layer 942, a pinned layer (P) 944, and an antiferromagnetic layer (AF) 946. The P layer 944 may comprise one or more F layers, or a synthetic antiferromagnet (SAF) comprising two F layers separated by a nonmagnetic interlayer (I) providing antiferromagnetic coupling between the F layers. The I layer may comprise a layer of ruthenium (Ru) that has an appropriate thickness. The AF layer 946 pins the magnetization of the P layer 944 and comprises an alloy of nickel manganese (NiMn) or iridium manganese (IrMn). All of the layers in the active stack 910 are deposited, one at a time, by DC magnetron sputtering in the order shown in FIG. 9 and described above. The PART OX layer 920 is oxidized as described above with reference to FIGS. 8-1, 8-2, and 8-3.

The PART OX layer 920 has two larger dimensions, a length and a width, and a smaller thickness. An area of the PART OX layer 920 is defined by its length and its width and is as large as, or larger, than a corresponding area of the active stack 910.

The PART OX layer 920 can be located anywhere between the first shield 912 and the second shield 914. For example, the PART OX layer 920 can be between the cap layer 930 and the second shield 914, as shown in FIG. 9. The PART OX layer 920 may also be located between any of the adjacent layers in the active stack 910 including the cap layer 930, the F layer 940, the MN layer 942, the P layer 944, the AF layer 946, and the seed layer 932. The PART OX layer 920 can also be between the seed layer 932 and the first shield 912. There may also be multiple PART OX layers 920 distributed between the first shield 912 and the second shield 914 to increase the resistance of the active stack 910.

The seed layer 932 and the cap layer 930 may comprise tantalum (Ta), an alloy of nickel and iron (NiFe), an alloy of nickel, iron, and chromium (NiFeCr), copper (Cu), or other alloys containing chromium (Cr), iron (Fe), cobalt (Co), nickel (Ni) and/or copper (Cu). The seed layer 932 and the cap layer 930 may comprise different materials.

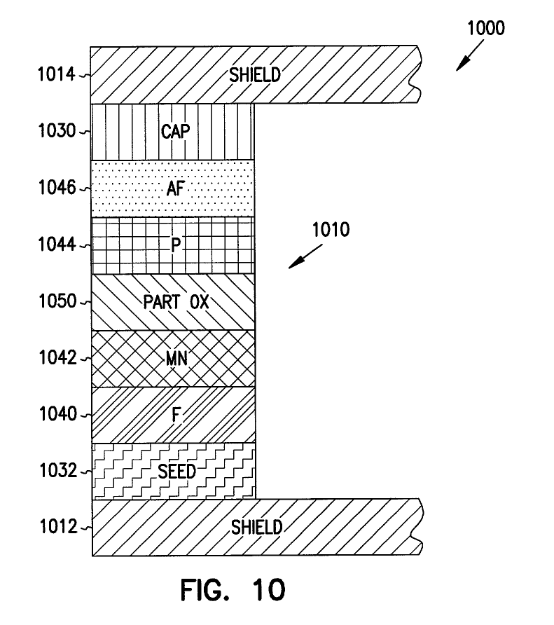

A cross-sectional view of a CPP transducer 1000 is shown in FIG. 10 according to an embodiment of the present invention. The cross-sectional view of the CPP transducer 1000 in FIG. 10 is not drawn to scale, and proportions of each element may be different in a fabricated CPP transducer 1000. The CPP transducer 1000 is a top spin valve transducer that has a high resistance, and comprises an active stack 1010 between a first shield 1012 and a second shield 1014. Between a cap layer 1030 and a seed layer 1032, the active stack 1010 includes an F layer 1040, a MN layer 1042, a P layer 1044, and an AF layer 1046. The active stack 1010 includes a PART OX layer 1050 between the MN layer 1042 and the P layer 1044 to increase the resistance of the active stack 1010. The PART OX layer 1050 is in the middle of the active stack 1010. All of the layers in the active stack 1010 are deposited, one at a time, by DC magnetron sputtering in the order shown in FIG. 10 and described above. The PART OX layer 1050 is oxidized as described above with reference to FIGS. 8-1, 8-2, and 8-3.

The PART OX layer 1050 has two larger dimensions, a length and a width, and a smaller thickness. An area of the PART OX layer 1050 is defined by its length and its width and is as large as, or larger, than a corresponding area of the active stack 1010.

The PART OX layer 1050 can be located anywhere between the first shield 1012 and the second shield 1014. For example, the PART OX layer 1050 can be between the P layer 1044 and the MN layer 1042 as shown in FIG. 10. The PART OX layer 1020 may also be located between any of the other adjacent layers in the active stack 1010 including the cap layer 1030, the AF layer 1046, and the P layer 1044, or between the seed layer 1032, the F layer 1040, and the MN layer 1042. The PART OX layer 1050 can also be between the seed layer 1032 and the first shield 1012, or between the cap layer 1030 and the second shield 1014. There may also be multiple PART OX layers 1050 distributed between the first shield 1012 and the second shield 1014 to increase the resistance of the active stack 1010.

The seed layer 1032 and the cap layer 1030 may comprise tantalum (Ta), an alloy of nickel and iron (NiFe), an alloy of nickel, iron, and chromium (NiFeCr), copper (Cu), or other alloys containing chromium (Cr), iron (Fe), cobalt (Co), nickel (Ni) and/or copper (Cu). The seed layer 1032 and the cap layer 1030 may comprise different materials.

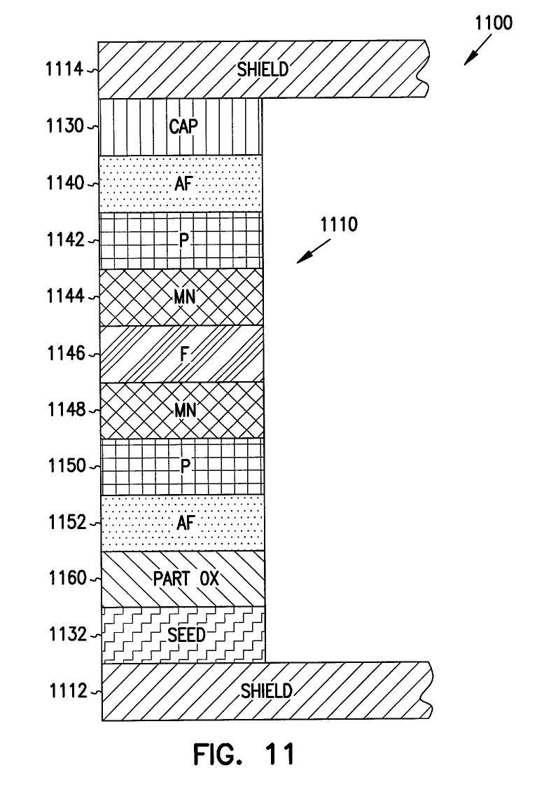

A cross-sectional view of a CPP transducer 1100 is shown in FIG. 11 according to an embodiment of the present invention. The cross-sectional view of the CPP transducer 1100 in FIG. 11 is not drawn to scale, and proportions of each element may be different in a fabricated CPP transducer 1100. The CPP transducer 1100 is a dual spin valve transducer that has a high resistance, and comprises an active stack 1110 between a first shield 1112 and a second shield 1114. Between a cap layer 1130 and a seed layer 1132, in order, the active stack 1110 includes an AF layer 1140, a P layer 1142, a MN layer 1144, an F layer 1146, a MN layer 1148, a P layer 1150, and an AF layer 1152. A PART OX layer 1160 is located between the AF layer 1152 and the seed layer 1132 to increase the resistance of the active stack 1110. All of the layers in the active stack 1110 are deposited, one at a time, by DC magnetron sputtering in the order shown in FIG. 11 and described above. The PART OX layer 1160 is oxidized as described above with reference to FIGS. 8-1, 8-2, and 8-3.

The PART OX layer 1160 has two larger dimensions, a length and a width, and a smaller thickness. An area of the PART OX layer 1160 is defined by its length and its width and is as large as, or larger, than a corresponding area of the active stack 1110.

The PART OX layer 1160 can be located anywhere between the first shield 1112 and the second shield 1114. For example, the PART OX layer 1160 can be between the seed layer 1132 and the AF layer 1152, as shown in FIG. 11. The PART OX layer 1160 may also be located between any of the other adjacent layers in the active stack 1110 including the cap layer 1130, the AF layer 1140, the P layer 1142, the MN layer 1144, the F layer 1146, the MN layer 1148, the P layer 1150, and the AF layer 1152. The PART OX layer 1160 can also be between the seed layer 1132 and the first shield 1112, or between the cap layer 1130 and the second shield 1114. There may also be multiple PART OX layers 1160 distributed between the first shield 1112 and the second shield 1114 to increase the resistance of the active stack 1110.

The seed layer 1132 and the cap layer 1130 may comprise tantalum (Ta), an alloy of nickel and iron (NiFe), an alloy of nickel, iron, and chromium (NiFeCr), copper (Cu), or other alloys containing chromium (Cr), iron (Fe), cobalt (Co), nickel (Ni) and/or copper (Cu). The seed layer 1132 and the cap layer 1130 may comprise different materials.

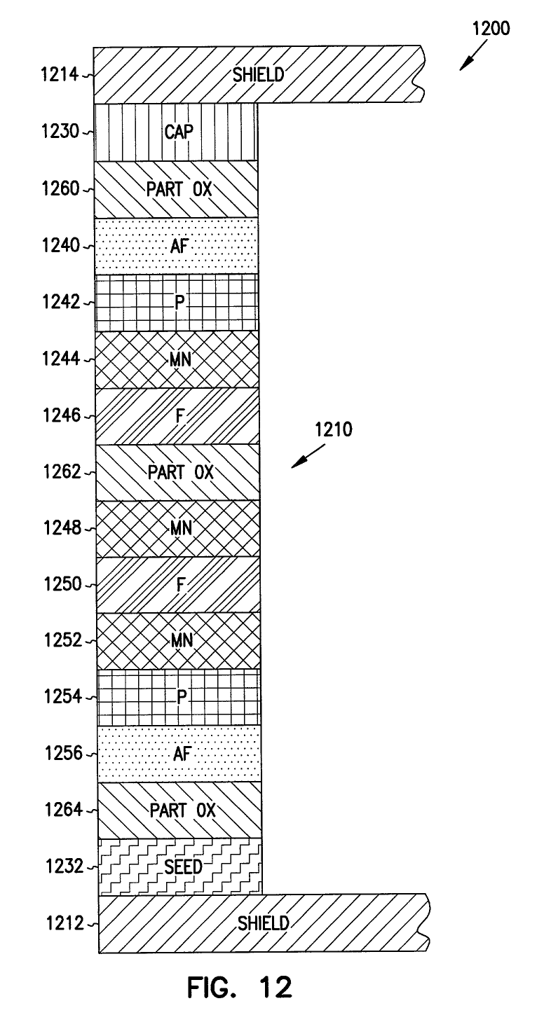

A cross-sectional view of a CPP transducer 1200 is shown in FIG. 12 according to an embodiment of the present invention. The cross-sectional view of the CPP transducer 1200 in FIG. 12 is not drawn to scale, and proportions of each element may be different in a fabricated CPP transducer 1200. The CPP transducer 1200 is a differential spin valve transducer that has a high resistance, and comprises an active stack 1210 between a first shield 1212 and a second shield 1214. Between a cap layer 1230 and a seed layer 1232, in order, the active stack 1210 includes an AF layer 1240, a P layer 1242, a MN layer 1244, an F layer 1246, a MN layer 1248, an F layer 1250, a MN layer 1252, a P layer 1254, and an AF layer 1256. Three PART OX layers 1260, 1262, and 1264 are distributed within the active stack 1210 to increase the resistance of the active stack 1210. All of the layers in the active stack 1210 are deposited, one at a time, by DC magnetron sputtering in the order shown in FIG. 12 and described above. Each of the PART OX layers 1260, 1262, and 1264 is oxidized as described above with reference to FIGS. 8-1, 8-2, and 8-3.

Each of the PART OX layers 1260, 1262, and 1264 has two larger dimensions, a length and a width, and a smaller thickness. An area of each PART OX layer 1260, 1262, or 1264 is defined by its length and its width and is as large as, or larger, than a corresponding area of the active stack 1210.

The PART OX layers 1260, 1262, and 1264 are distributed in the active stack 1210, and one of them can be located between any two of the cap layer 1230, the AF layer 1240, the P layer 1242, the MN layer 1244, the F layer 1246, the MN layer 1248, the F layer 1250, the MN layer 1252, the P layer 1254, the AF layer 1256, and the seed layer 1232. One of the PART OX layers 1260, 1262, and 1264 can also be between the seed layer 1232 and the first shield 1212, and/or between the cap layer 1230 and the second shield 1214.

The seed layer 1232 and the cap layer 1230 may comprise tantalum (Ta), an alloy of nickel and iron (NiFe), an alloy of nickel, iron, and chromium (NiFeCr), copper (Cu), or other alloys containing chromium (Cr), iron (Fe), cobalt (Co), nickel (Ni) and/or copper (Cu). The seed layer 1232 and the cap layer 1230 may comprise different materials.

A side view of a non-floated single-pole perpendicular read/write head 1300 is shown in FIG. 13 according to an embodiment of the present invention. The read/write head 1300 is one example of the read/write head 128 shown in FIG. 1, and is shown positioned near a cross-sectional view of one of the discs 134 shown in FIG. 1. The disc 134 has a perpendicular magnetic recording medium thereon which is written to and read from by the perpendicular read/write head 1300.

The read/write head 1300 includes a main magnetic pole 1310 that is fixed between two substrates 1312 and 1314 that are insulating and comprise ceramic or another insulating material. An electrically conductive coil 1318 is wound around the main magnetic pole 1310 and is electrically insulated by an appropriate EN/MN support structure (not shown). The circuits 160 are connected to opposed ends of the coil 1318, and during a write mode the circuits 160 send electrical current IW passing through the coil 1318 to write information to the disc 134. The main magnetic pole 1310 and the substrates 1312 and 1314 are mounted to a ferrite core 1320 that is mounted on an arm 1322 so as to be guided to move relative to the disc 134. The main magnetic pole 1310 is forced toward the disc 134 by gravity or by a spring (not shown) to be pressed in contact with the disc 134 with a suitable pressure.

Cross-sectional views of main magnetic poles that may be selected as the main magnetic pole 1310 shown in FIG. 13 are shown in FIG. 14 and FIG. 15. These main magnetic poles are only examples of a variety of main magnetic poles useful in perpendicular read/write heads that may include one of the active stacks 510, 910, 1010, 1110, 1210 shown in FIGS. 5, 9, 10, 11, and 12, respectively, according to embodiments of the present invention. Each of the active stacks 510, 910, 1010, 1110, 1210 shown in FIGS. 5, 9, 10, 11, and 12, respectively, may be used with equal success in a wide variety of longitudinal and perpendicular read/write heads.

A cross-sectional view of a main magnetic pole 1400 is shown in FIG. 14 according to an embodiment of the present invention. The main magnetic pole 1400 may be substituted for the main magnetic pole 1310 shown in FIG. 13. An electrically conductive coil 1410 is deposited on an insulating layer 1412 that comprises an EN/MX material such as Al₂O₃, hard-baked photoresist, or benzocyclobutene (BCB). The coil 1410 is shown having 3 turns, and could have more or less turns according to alternate embodiments of the present invention. The coil 1410 is also surrounded by an insulator 1414 that may also comprise A1₂O₃, hard-baked photoresist, or benzocyclobutene (BCB). The coil 1410 is wrapped around a magnetic yoke 1416 that is both magnetically and electrically conductive (an EC/MC material) and may comprise a nickel-iron composition, for example an alloy of 80% nickel (Ni) and 20% iron (Fe), or a ferromagnetic material with high permeability. A magnetic thin film 1418 is deposited at a tip end of the yoke 1416, and the magnetic thin film 1418 and the yoke 1416 are supported by a ceramic substrate 1420 that is shown in a cut-away view for purposes of brevity. The circuits 160, also shown in FIG. 1, are connected to opposed ends of the coil 1410, and during a write mode the circuits 160 send electrical current Iw passing through the coil 1410 to write information to the disc 134 shown in FIG. 13 through the yoke 1416 and the magnetic thin film 1418.

A CPP transducer is formed in the main magnetic pole 1400 and includes the following elements. A shield 1426 in the main magnetic pole 1400 comprises a material that is both magnetically and electrically conductive (an EC/MC material), and is fabricated on the insulating layer 1412. The shield 1426 may comprise a nickel-iron composition, for example an alloy of 80% nickel (Ni) and 20% iron (Fe), or a ferromagnetic material with high permeability. The insulating layer 1412 may be perforated by a magnetic via (not shown) that connects the shield 1426 to the yoke 1416. An active stack 1430 of a CPP transducer is located below the shield 1426 and is separated from the shield 1426 by a cap layer 1432. The active stack 1430 may comprise one of the active stacks 510, 910, 1010, 1110, 1210 shown in FIGS. 5, 9, 10, 11, and 12, respectively, according to embodiments of the present invention. A seed layer 1434 separates the active stack 1430 from a soft magnetic layer 1436 that comprises a material that is both magnetically and electrically conductive (an EC/MC material) such as a nickel-iron composition, for example an alloy of 80% nickel (Ni) and 20% iron (Fe), or a ferromagnetic material with high permeability. The soft magnetic layer 1436 is connected to the circuits 160 to receive a sense current I_{R}. The sense current I_{R} flows through the soft magnetic layer 1436, the seed layer 1434, the active stack 1430 in a direction approximately normal or perpendicular to a plane defined by the two largest dimensions of the active stack 1430, the cap layer 1432, the shield 1426, and back to the circuits 160. The active stack 1430 undergoes changes in its electrical resistance as it passes over the disc 134, and the changes in the resistance of the active stack 1430 are sensed by the circuits 160 by sensing changes in the sense current I_{R}, or by sensing changes in a voltage drop across the active stack 1430 when the sense current I_{R} remains approximately constant. Volume between the soft magnetic layer 1436 and the shield 1426 is filled with an EN/MX material 1442 such as Al₂O₃, hard-baked photoresist, or benzocyclobutene (BCB).

A cross-sectional view of a main magnetic pole 1500 is shown in FIG. 15 according to an embodiment of the present invention. The main magnetic pole 1500 may be substituted for the main magnetic pole 1310 shown in FIG. 13. An electrically conductive coil 1510 is deposited on a first insulating layer 1512 that comprises an ENIMX material such as Al₂O₃, hard-baked photoresist, or benzocyclobutene (BCB). The coil 1510 is shown having 9 turns, and could have more or less turns according to alternate embodiments of the present invention. The coil 1510 is also surrounded by an insulator 1514 that may also comprise Al₂O₃, hard-baked photoresist, or benzocyclobutene (BCB). The coil 1510 is wrapped around a magnetic yoke 1516 that is both magnetically and electrically conductive (an EC/MC material) and may comprise a nickel-iron composition, for example an alloy of 80% nickel (Ni) and 20% iron (Fe), or a ferromagnetic material with high permeability. A magnetic thin film 1518 is deposited at a tip end of the yoke 1516, and a protective layer 1520 is formed over the magnetic thin film 1518 and the yoke 1516. The protective layer 1520 is shown in a cut-away view for purposes of brevity. The circuits 160, also shown in FIG. 1, are connected to opposed ends of the coil 1510, and during a write mode the circuits 160 send electrical current IW passing through the coil 1510 to write information to the disc 134 shown in FIG. 13 through the yoke 1516 and the magnetic thin film 1518. A first shield 1522 comprises a material that is both magnetically and electrically conductive (an EC/MC material), and is fabricated on the first insulating layer 1512. The first shield 1522 may comprise a nickel-iron composition, for example an alloy of 80% nickel (Ni) and 20% iron (Fe), or a ferromagnetic material with high permeability. The first insulating layer 1512 may be perforated by a magnetic via (not shown) that connects the first shield 1522 to the yoke 1516.

A CPP transducer is formed in the main magnetic pole 1500 and includes the following elements. A second insulating layer 1524 that comprises an EN/MX material such as Al₂O₃, hard-baked photoresist, or benzocyclobutene (BCB) is fabricated on the first shield 1522 to separate the first shield 1522 from a second shield 1526. The second shield 1526 comprises a material that is both magnetically and electrically conductive (an EC/MC material), and is fabricated on the second insulating layer 1524. The second shield 1526 may comprise a nickel-iron composition, for example an alloy of 80% nickel (Ni) and 20% iron (Fe), or a ferromagnetic material with high permeability. An active stack 1530 of a CPP transducer is located below the second shield 1526 and is separated from the second shield 1526 by a cap layer 1532. The active stack 1530 may comprise one of the active stacks 510, 910, 1010, 1110, 1210 shown in FIGS. 5, 9, 10, 11, and 12, respectively, according to embodiments of the present invention. A seed layer 1534 separates the active stack 1530 from a soft magnetic layer 1536 that comprises a material that is both magnetically and electrically conductive (an EC/MC material) such as a nickel-iron composition, for example an alloy of 80% nickel (Ni) and 20% iron (Fe), or a ferromagnetic material with high permeability. The soft magnetic layer 1536 is connected to the circuits 160 to receive a sense current I_{R}. The sense current I_{R} flows through the soft magnetic layer 1536, the seed layer 1534, the active stack 1530 in a direction approximately normal or perpendicular to a plane defined by the two largest dimensions of the active stack 1530, the cap layer 1532, the second shield 1526, and back to the circuits 160. The active stack 1530 undergoes changes in its electrical resistance as it passes over the disc 134, and the changes in the resistance of the active stack 1530 are sensed by the circuits 160 by sensing changes in the sense current I_{R}, or by sensing changes in a voltage drop across the active stack 1530 when the sense current I_{R} remains approximately constant. Volume between the soft magnetic layer 1536 and the second shield 1526 is filled with an EN/MX material 1542 such as Al₂O₃, hard-baked photoresist, or benzocyclobutene (BCB).

Each one of the CPP transducers shown in FIGS. 5, 9, 10, 11, and 12 according to embodiments of the invention may be chosen as the CPP transducer in the read/write head 200 shown in FIG. 2, the read/write head 300 shown in FIG. 3, the main magnetic pole 1400 shown in FIG. 14, or the main magnetic pole 1500 shown in FIG. 15, according to embodiments of the present invention. The active stack 211 shown in FIG. 2, the active stack 310 shown in FIG. 3, the active stack 1430 shown in FIG. 14, or the active stack 1530 shown in FIG. 15 may each comprise one of the active stacks 510, 910, 1010, 1110, 1210 shown in FIGS. 5, 9, 10, 11, and 12, respectively, according to embodiments of the present invention.

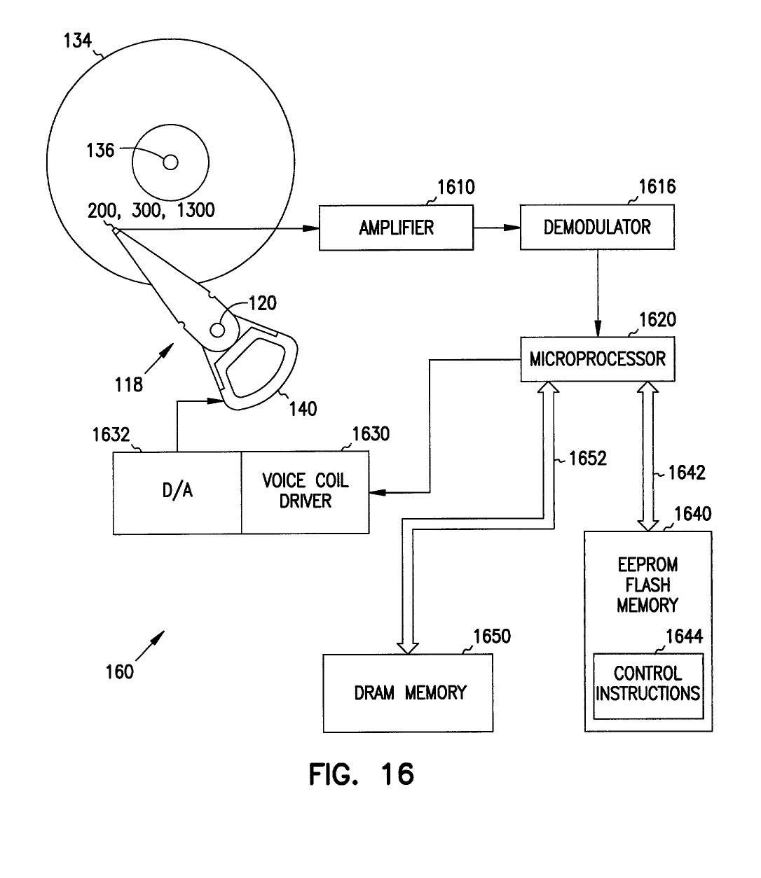

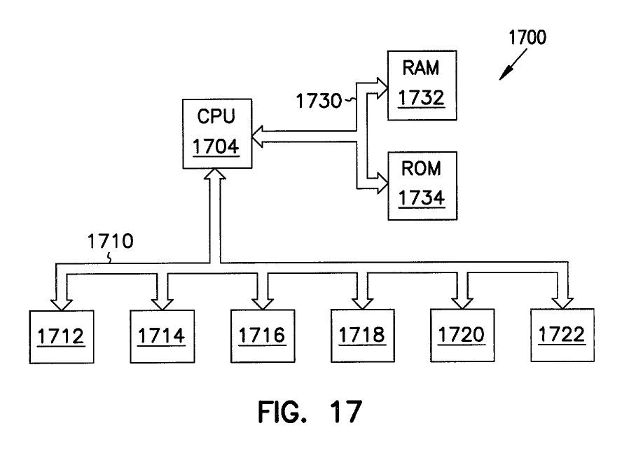

A block diagram of the actuator assembly 118, the discs 134, and the circuits 160 of the disc drive 100 is shown in FIG. 16 according to an embodiment of the present invention. Read/write heads 200 or 300 or 1300 as shown in FIGS. 2, 3, and 13 according to embodiments of the present invention are attached to the actuator assembly 118. The position of one of the read/write heads 200 or 300 or 1300 over one of the discs 134 is controlled by a feedback control system in the circuits 160. Those skilled in the art with the benefit of the present description will understand that the circuits 160 control the position of all the read/write heads 200 or 300 or 1300 relative to all of the discs 134, either one at a time or simultaneously.

The feedback control system includes an amplifier 1610 to amplify a read/write signal generated by one of the read/write heads 200 or 300 or 1300 as it is reading information from one of the discs 134. The read/write signal amplified by the amplifier 1610 is demodulated by a demodulator 1616 and provided to a microprocessor 1620 that controls most operations of the disc drive 100. The microprocessor 1620 generates a control signal to control a movement of the actuator assembly 118. The control signal is coupled to a voice coil driver 1630 which generates a driver signal that is converted by a digital-to-analog (D/A) converter circuit 1632 into an analog driver signal that is applied to the voice coil 140.

The microprocessor 1620 is coupled to an EEPROM flash memory device 1640 through a bus 1642 to exchange information with the flash memory device 1640. The flash memory device 1640 is a computer-readable medium that stores computer-readable and computer-executable instructions or data. The computer-readable and computer-executable instructions include control instructions 1644 in the form of assembly code. The microprocessor 1620 retrieves and executes the instructions 1644 to control the movement of the actuator assembly 118. The microprocessor 1620 is also coupled to exchange information with a DRAM memory device 1650 through a bus 1652. The DRAM memory device 1650 is a computer-readable medium that comprises computer-readable and computer-executable instructions or data.

A block diagram of an information handling system 1700 is shown in FIG. 17 according to an embodiment of the present invention. The information handling system 1700 may also be called an electronic system or a computer system. The information handling system 1700 includes a central processing unit (CPU) 1704 coupled to exchange information through a bus 1710 with several peripheral devices 1712, 1714, 1716, 1718, 1720, and 1722. The peripheral devices 1712-1722 include the disc drive 100 according to embodiments of the present invention, and may also include a magneto optical drive, a floppy disc drive, a monitor, a keyboard, and other such peripherals. The CPU 1704 is also coupled to exchange information through a bus 1730 with a random access memory (RAM) 1732 and a read-only memory (ROM) 1734.

The embodiments of the present invention described above provide for an accurate reading of information that is stored in a high density fashion in ferromagnetic media. CPP transducers described herein according to embodiments of the present invention include a non-continuous insulating interlayer comprising aluminum (Al) and aluminum oxide (AlOₓ) that increases the resistance of an active stack in the CPP transducer. The increased resistance results in greater fluctuations in a sense current I_{R} in the active stack, or greater changes in a voltage drop across the active stack, when the active stack is exposed to a time-varying magnetic flux in the ferromagnetic media. The increased fluctuations in the sense current I_{R} or the voltage drop are easier to detect, and improve the accuracy of reading information that is stored in a high density fashion in ferromagnetic media.

Those skilled in the art having the benefit of this description can appreciate that the present invention may be practiced with any variety of system. Such systems may include, for example, a video game, a personal computer, a server, a workstation, a television, a routing switch, or a multi-processor computer system, or an information appliance such as, for example, or a daily planner or organizer, or an information component such as, for example, a telecommunications modem.

### Conclusion

In conclusion, a read/write head 128, 200, 300, 1300 for a disc drive 100 is disclosed. The read/write head 128, 200, 300, 1300 includes a first shield 220, 512, 912, 1012, 1112, 1212, 1426, a second shield 226, 514, 914, 1014, 1114, 1214, 1526, and an active stack 211, 310, 510, 910, 1010, 1110, 1210, 1430, 1530 between and in contact with the first shield 220, 512, 912, 1012, 1112, 1212, 1426 and the second shield 226, 514, 914, 1014, 1114, 1214, 1526. The active stack 211, 310, 510, 910, 1010, 1110, 1210, 1430, 1530 includes a plurality of layers and a non-continuous insulating interlayer 540, 920, 1050, 1160, 1260, 1262, 1264. The active stack 211, 310, 510, 910, 1010, 1110, 1210, 1430, 1530 may include a seed layer 222, 314, 530, 932, 1032, 1132, 1232, 1434, 1534, a cap layer 224, 312, 532, 930, 1030, 1130, 1230, 1432, 1532, and a plurality of alternating ferromagnetic layers 520, 940, 1040, 1146, 1246, 1250 and magnetically nonconductive layers 522, 942, 1042, 1144, 1148, 1244, 1248, 1252 in contact with each other, each magnetically nonconductive layer 522, 942, 1042, 1144, 1148, 1244, 1248, 1252 being in contact with an adjacent ferromagnetic layer 520, 940, 1040, 1146, 1246, 1250. The non-continuous insulating interlayer 540, 920, 1050, 1160, 1260, 1262, 1264 may be in contact with one of the ferromagnetic layers 520, 940, 1040, 1146, 1246, 1250, the magnetically nonconductive layers 522, 942, 1042, 1144, 1148, 1244, 1248, 1252, the seed layer 222, 314, 530, 932, 1032, 1132, 1232, 1434, 1534, or the cap layer 224, 312, 532, 930, 1030, 1130, 1230, 1432, 1532. Alternatively, the active stack 211, 310, 510, 910, 1010, 1110, 1210, 1430, 1530 may include a seed layer 222, 314, 530, 932, 1032, 1132, 1232, 1434, 1534, a cap layer 224, 312, 532, 930, 1030, 1130, 1230, 1432, 1532, a ferromagnetic layer 520, 940, 1040, 1146, 1246, 1250, a magnetically nonconductive layer 522, 942, 1042, 1144, 1148, 1244, 1248, 1252, a pinned layer 944, 1044, 1142, 1150, 1242, 1254, and an antiferromagnetic layer 946, 1046, 1140, 1152, 1240, 1256. The non-continuous insulating interlayer 540, 920, 1050, 1160, 1260, 1262, 1264 may be in contact with one of the ferromagnetic layer 520, 940, 1040, 1146, 1246, 1250, the magnetically nonconductive layer 522, 942, 1042, 1144, 1148, 1244, 1248, 1252, the pinned layer 944, 1044, 1142, 1150, 1242, 1254, the antiferromagnetic layer 946, 1046, 1140, 1152, 1240, 1256, the seed layer 222, 314, 530, 932, 1032, 1132, 1232, 1434, 1534, or the cap layer 224, 312, 532, 930, 1030, 1130, 1230, 1432, 1532. The non-continuous insulating interlayer 540, 920, 1050, 1160, 1260, 1262, 1264 may include a material and an oxide of the material, such as aluminum (Al) 730 and aluminum oxide (AlOₓ) 720, or tantalum and tantalum oxide or copper and copper oxide. The material may also be selected from the group consisting of nickel, cobalt, iron, and their binary and tertiary alloys. The non-continuous insulating interlayer 540, 920, 1050, 1160, 1260, 1262, 1264 may have approximately 5% aluminum (Al) 730 and approximately 95% aluminum oxide (AlOx) 720, or approximately 10% aluminum (Al) 730 and approximately 90% aluminum oxide (AlOₓ) 720. The read/write head 128, 200, 300, 1300 may be a perpendicular read/write head 1300. A disc drive 100 including the read/write head 128, 200, 300, 1300 may also include a base 112, a disc 134 rotatably attached to the base 112, and an actuator assembly 118 attached to the base 112. One end of the actuator assembly 118 includes the read/write head 128, 200, 300, 1300, and another end of the actuator assembly 118 includes a voice coil 140 which forms a portion of a voice coil motor 140, 142, 144. A circuit 160 is coupled to the read/write head 128, 200, 300, 1300 to exchange signals with the read/write head 128, 200, 300, 1300 to read information from and write information to the disc 134. An information handling system including the disc drive 100 may also include a bus 1710, 1730 coupled to the disc drive 100, a central processing unit 1704 coupled to the bus 1710, 1730, and peripheral devices 1712, 1714, 1716, 1718, 1720, 1722, 1732, 1734 coupled to the bus 1710, 1730.

A method of operating a disc drive 100 is also disclosed. The method includes rotating a disc 134 comprising a magnetizable medium 205, 1305, positioning a read/write head 128, 200, 300, 1300 proximate to the magnetizable medium 205, 1305, and coupling a sense current I_{R} through an active stack 211, 310, 510, 910, 1010, 1110, 1210, 1430, 1530 in the read/write head 128, 200, 300, 1300. The active stack 211, 310, 510, 910, 1010, 1110, 1210, 1430, 1530 has two larger dimensions TW, SH, 710, 712 and a smaller dimension 714 and includes a number of layers and a non-continuous insulating interlayer 540, 920, 1050, 1160, 1260, 1262, 1264. The sense current I_{R} is coupled to flow in a direction that is approximately normal or perpendicular to a plane defined by the two larger dimensions TW, SH, 710, 712 of the active stack 211, 310, 510, 910, 1010, 1110, 1210, 1430, 1530. The method also includes detecting changes in the sense current I_{R} or in a voltage drop across the active stack 211, 310, 510, 910, 1010, 1110, 1210, 1430, 1530 to detect changes in flux fields 207, 209 caused by changes in magnetic flux regions 204 in the magnetizable medium 205, 1305. The method may also include coupling the sense current I_{R} through the non-continuous insulating interlayer 540, 920, 1050, 1160, 1260, 1262, 1264 that includes a material and an oxide of the material such as aluminum (Al) 730 and aluminum oxide (AlOₓ) 720.

A method of fabricating an active stack 211, 310, 510, 910, 1010, 1110, 1210, 1430, 1530 in a read/write head 128, 200, 300, 1300 in a disc drive 100 is also disclosed. The disc drive 100 includes a base 112, a disc 134 rotatably attached to the base 112 and having a surface coated with a magnetizable medium 205, 1305, a movable actuator assembly 118 attached to the base 112, the actuator assembly 118 including the read/write head 128, 200, 300, 1300 attached to a load spring to movably suspend the read/write head 128, 200, 300, 1300 from the actuator assembly 118 near the surface of the disc 134, the disc 134 to store representations of information in the magnetizable medium 205, 1305 to be written to or read from the disc 134 by the read/write head 128, 200, 300, 1300, and a circuit 160 coupled to the read/write head 128, 200, 300, 1300 to exchange signals with the read/write head 128, 200, 300, 1300 to read information from and write information to the disc 134. The method includes fabricating a number of layers, fabricating a non-continuous insulating interlayer 540, 920, 1050, 1160, 1260, 1262, 1264 in contact with one of the layers, and attaching the layers with the non-continuous insulating interlayer 540, 920, 1050, 1160, 1260, 1262, 1264 between a first shield 220, 512, 912, 1012, 1112, 1212, 1426 and a second shield 226, 514, 914, 1014, 1114, 1214, 1526 in the read/write head 128, 200, 300, 1300. The non-continuous insulating interlayer 540, 920, 1050, 1160, 1260, 1262, 1264 is fabricated by depositing a layer of a material, exposing the layer of material to oxygen to oxidize the material, and stopping the exposure of the material to oxygen when a selected percentage of the material has been oxidized. For example, the non-continuous insulating interlayer 540, 920, 1050, 1160, 1260, 1262, 1264 is fabricated by depositing a layer of aluminum (Al) 730, exposing the layer of aluminum (Al) 730 to oxygen to oxidize the aluminum (Al) 730, and stopping the exposure of the aluminum (Al) 730 to oxygen when a selected percentage of the aluminum (Al) 730 has been oxidized into aluminum oxide (AlOₓ) 720.

Also disclosed is a disc drive system 100 including a disc 134 mounted to rotate about an axis and a read/write head 128, 200, 300, 1300 with a non-continuous insulating interlayer 540, 920, 1050, 1160, 1260, 1262, 1264 for sensing changes in a magnetic field on a surface of the disc 134.

It is to be understood that the above description is intended to be illustrative, and not restrictive. Many other embodiments will be apparent to those of skill in the art upon reviewing the above description. For example, each of the active stacks 510, 910, 1010, 1110, 1210 shown in FIGS. 5, 9, 10, 11, and 12, respectively, may be used with equal success in a wide variety of longitudinal and perpendicular read/write heads. The scope of the invention should, therefore, be determined with reference to the appended claims, along with the full scope of equivalents to which such claims are entitled.

What is claimed is:

1. A read/write head for a disc drive, the read/write head comprising:
a first shield;
a second shield; and
an active stack between and in contact with the first shield and the second shield, the active stack comprising:
a plurality of layers; and
a non-continuous insulating interlayer.

2. The read/write head of claim 1 wherein the active stack further comprises a seed layer, a cap layer, and a plurality of alternating ferromagnetic layers and magnetically nonconductive layers in contact with each other, each magnetically nonconductive layer being in contact with an adjacent ferromagnetic layer, the non-continuous insulating interlayer being in contact with one of the ferromagnetic layers, the magnetically nonconductive layers, the seed layer, or the cap layer.

3. The read/write head of claim 1 wherein the active stack further comprises a seed layer, a cap layer, a ferromagnetic layer, a magnetically nonconductive layer, a pinned layer, and an antiferromagnetic layer, the non-continuous insulating interlayer being in contact with one of the ferromagnetic layer, the magnetically nonconductive layer, the pinned layer, the antiferromagnetic layer, the seed layer, or the cap layer.

4. The read/write head of claim 1 wherein the non-continuous insulating interlayer comprises a material and an oxide of the material.

5. The read/write head of claim 1 wherein the non-continuous insulating interlayer comprises aluminum and aluminum oxide.

6. The read/write head of claim 1 wherein the non-continuous insulating interlayer comprises approximately 5% aluminum and approximately 95% aluminum oxide.

7. The read/write head of claim 1 wherein the non-continuous insulating interlayer comprises approximately 10% aluminum and approximately 90% aluminum oxide.

8. The read/write head of claim 4 wherein the material is selected from the group consisting of nickel, cobalt, iron, and their binary and tertiary alloys.

9. The read/write head of claim 1 wherein the read/write head comprises a perpendicular read/write head.

10. The read/write head of claim 1 wherein the non-continuous insulating interlayer comprises tantalum and tantalum oxide or copper and copper oxide.

11. A disc drive of the type including the read/write head of claim 1, and further comprising:
a base;
a disc rotatably attached to the base;
an actuator assembly attached to the base, one end of the actuator assembly comprising the read/write head and another end of the actuator assembly comprising a voice coil which forms a portion of a voice coil motor; and
a circuit coupled to the read/write head to exchange signals with the read/write head to read information from and write information to the disc.

12. An information handling system of the type including the disc drive of claim 11, and further comprising:
a bus operatively coupled to the disc drive;
a central processing unit operatively coupled to the bus; and
peripheral devices operatively coupled to the bus.

13. A method of operating a disc drive, the method comprising:
rotating a disc comprising a magnetizable medium;
positioning a read/write head proximate to the magnetizable medium;
coupling a sense current through an active stack in the read/write head, the active stack having two larger dimensions and a smaller dimension and comprising a plurality of layers and a non-continuous insulating interlayer, the sense current being coupled to flow in a direction that is approximately normal or perpendicular to a plane defined by the two larger dimensions of the active stack; and
detecting changes in the sense current or in a voltage drop across the active stack to detect changes in flux fields caused by changes in magnetic flux regions in the magnetizable medium.

14. The method of claim 13 wherein coupling a sense current further comprises coupling the sense current through the non-continuous insulating interlayer that comprises a material and an oxide of the material.

15. The method of claim 13 wherein coupling a sense current further comprises coupling the sense current through the non-continuous insulating interlayer that comprises aluminum and aluminum oxide.

16. A method of fabricating an active stack in a read/write head in a disc drive including a base, a disc rotatably attached to the base and having a surface coated with a magnetizable medium, a movable actuator assembly attached to the base, the actuator assembly including the read/write head attached to a load spring to movably suspend the read/write head from the actuator assembly near the surface of the disc, the disc to store representations of information in the magnetizable medium to be written to or read from the disc by the read/write head, and a circuit coupled to the read/write head to exchange signals with the read/write head to read information from and write information to the disc, the method comprising:
fabricating a plurality of layers;
fabricating a non-continuous insulating interlayer in contact with one of the layers; and
attaching the plurality of layers with the non-continuous insulating interlayer between a first shield and a second shield in the read/write head.

17. The method of claim 16 wherein fabricating a non-continuous insulating interlayer further comprises:
depositing a layer of a material;
exposing the layer of material to oxygen to oxidize the material; and
stopping the exposure of the material to oxygen when a selected percentage of the material has been oxidized.

18. The method of claim 16 wherein fabricating a non-continuous insulating interlayer further comprises:
depositing a layer of aluminum;
exposing the layer of aluminum to oxygen to oxidize the aluminum; and
stopping the exposure of the aluminum to oxygen when a selected percentage of the aluminum has been oxidized into aluminum oxide.

19. A disc drive system comprising:
a disc mounted to rotate about an axis;
means for sensing changes in a magnetic field on a surface of the disc.
